(19) United States
(12) Patent Application Publication
(10) Pub. No.: US 2012/0228866 A1
(43) Pub. Date: Sep. 13, 2012

(54) FUEL DELIVERY PIPE

(76) Inventor: Takayoshi OTA, Okazaki-shi (JP)

(21) Appl. No.: 13/402,976

(22) Filed: Feb. 23, 2012

(30) Foreign Application Priority Data
Mar. 10, 2011 (JP) 2011-053217
Feb. 1, 2012 (JP) 2012-019846

(51) Int. Cl. F16L 41/00

(52) U.S. Cl. 285/133.11

(57) ABSTRACT

A fuel delivery pipe includes a main pipe formed in a cylindrical shape and a mounting member. The main pipe includes a first pipe portion and a second pipe portion, and the second pipe portion is continuously formed from the first pipe portion and projected in a direction substantially perpendicular to an axis of the first pipe portion. The mounting member is provided on an outer peripheral surface of the main pipe and close to the second pipe portion.

### CROSS REFERENCE TO RELATED APPLICATION

This application claims priority from Japanese Patent Application No. 2011-053217 filed on Mar. 10, 2011 and Japanese Patent Application No. 2012-019846 filed on Feb. 1, 2012. The entire contents of the priority applications are incorporated herein by reference.

### FIELD OF THE INVENTION

The present disclosure relates to a fuel delivery pipe.

### BACKGROUND OF THE INVENTION

An internal combustion engine includes a fuel delivery pipe (referred to as a delivery pipe) that distributes fuel supplied from a fuel supply pipe to injectors provided in each cylinder. Such a delivery pipe is disclosed in Published patent application JP-A-2002-195125. Branch holes are formed on an outer peripheral surface of the delivery pipe. Each injector is connected to each branch hole via a connecting member such as an injector socket. Accordingly, fuel is supplied to each injector via the delivery pipe.

An engine layout may be changed in internal combustion engines. In changing the engine layout, the position of the injector maybe changed and accordingly the position of the fixing member that fixes the delivery pipe to the engine may be necessary to be changed. However, the position of the fixing member may not be able to be changed. In such a case, for example, a shape of the injector socket that connects the delivery pipe and the injector is required to be changed. This complicates the shape of the injector socket and this may increase a manufacturing cost of the delivery pipes. The change in shape of the injector socket may be restricted and this may restrict the engine layout.

### SUMMARY OF THE INVENTION

The present invention has been made in view of the aforementioned circumstances. An objective of the present invention is to provide technology that enables a free engine layout.

A technology described herein relates to a fuel delivery pipe includes a main pipe and a mounting member. The main pipe is formed in a cylindrical shape and includes a first pipe portion and a second pipe portion, and the second pipe portion is continuously formed from the first pipe portion and projected in a direction substantially perpendicular to an axis of the first pipe portion. The mounting member is provided on an outer peripheral surface of the main pipe and close to the second pipe portion.

### BRIEF DESCRIPTION OF THE DRAWINGS

FIG. 1 is a perspective view of a vehicle and illustrating a construction of a fuel supply device 50 of a present embodiment;

FIG. 2 is a typical view illustrating a fuel delivery pipe of the present embodiment;

FIG. 3 is a typical view illustrating the fuel delivery pipe seen from a side indicated by III in FIG. 2;

FIG. 4 is a typical view illustrating a fuel delivery pipe of another embodiment; and

FIG. 5 is a typical view illustrating a fuel delivery pipe of an additional embodiment.

### DETAILED DESCRIPTION OF THE PREFERRED EMBODIMENTS

An embodiment will be explained with reference to the drawings.

1. Construction of Fuel Supply Device of Vehicle

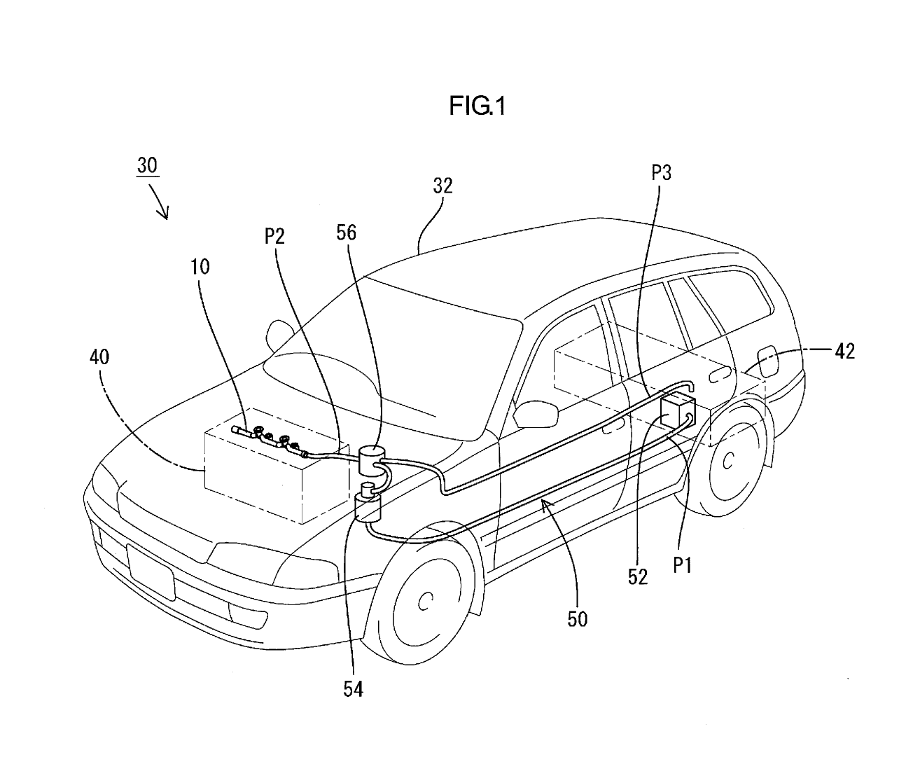

A fuel supply device 50 will be explained with reference to FIG. 1. The fuel supply device 50 is mounted in a vehicle body 32 of a vehicle 30 and supplies fuel from a fuel tank 42 to an engine 40. The fuel supply device 50 includes a fuel supply pump 52, a filter 54, a pressure regulator 56, a fuel transfer pipe P1, a fuel supply pipe P2, a fuel return pipe P3 and a fuel delivery pipe 10 (referred to as a delivery pipe).

The fuel supply pump 52 applies pressure on the fuel in the fuel tank 42. The fuel to which pressure is applied is transferred from the fuel tank 42 to the engine 40 via the fuel transfer pipe P1. The transferred fuel is filtered by the filter 54 and transferred to the fuel supply pipe P2 via the pressure regulator 56. Pressure of the fuel that is transferred to the fuel supply pipe P2 is adjusted by the pressure regulator 56. Apart of the fuel that is transferred to the fuel supply pipe P2 is supplied to the engine 40 via the delivery pipe 10 that is connected to the fuel supply pipe P2 and the rest of the fuel that is not transferred to the fuel supply pipe P2 is returned to the fuel tank 42 via the fuel return pipe P3.

The fuel includes gasoline, concentrated alcohol containing fuel or gasohol. For example, methanol, ethanol, butanol or propanol may be used as alcohol.

2. Construction of Delivery Pipe

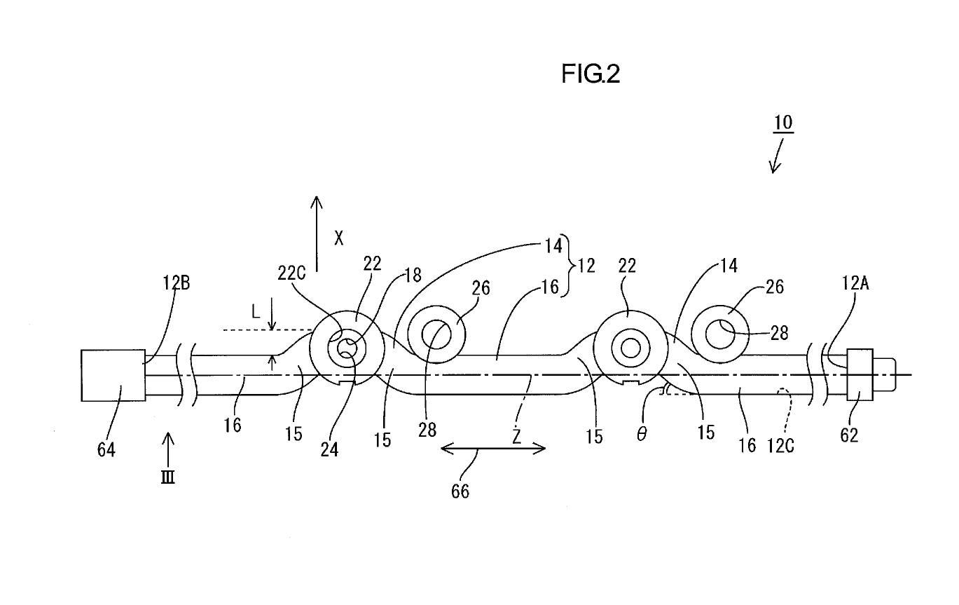

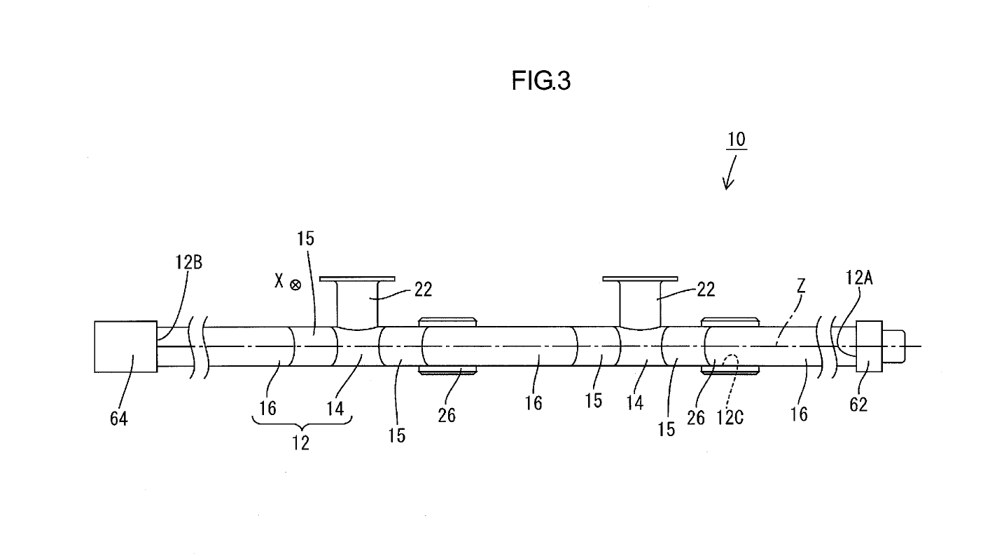

A construction of the delivery pipe 10 will be explained with reference to FIGS. 2 and 3. The delivery pipe 10 includes a main pipe 12, a plurality of injector sockets 22 (referred to as sockets) and a plurality of mounting bosses 26 (an example of a mounting member). The main pipe 12 is formed in substantially a cylindrical shape. The sockets 22 are connected to an outer peripheral surface of the main pipe 12 with brazing or welding. This connection of the sockets 22 and the main pipe 12 ensures sealing ability therebetween.

The main pipe 12 includes first pipe portions 16, second pipe portions 14 and connecting portions 15 each of which connects each first pipe portion 16 and each second pipe portion 14. The first pipe portions 16 are provided on an axis Z of the main pipe 12 connecting two ends 12A, 12B thereof and substantially straight along the axis Z. The second pipe portions 14 are provided with being projected from the axis Z by a distance L in a direction X (a radial direction of the first pipe portion 16) that is substantially perpendicular to the axis Z. Each of the second pipe portions 14 is projected from the axis Z in the same direction X by the same distance L. Each first pipe portion 16 and each second pipe portion 14 that are adjacent to each other are connected by the connecting portion 15. Accordingly, the main pipe 12 is formed in a cylindrical pipe as a whole.

The main pipe 12 is made of any metal such as steel, stainless or aluminum and formed by bending a straight cylindrical member (pipe). An angle θ formed between the connecting portion 15 and the axis Z is set to be approximately 60 degrees. If a diameter of the main pipe 12 is set to 14 mm, the radius of curvature of the connecting portion 15 is set to approximately 14 mm. The main pipe 12 includes a main pipe space 12C therein and the main pipe space 12C is formed in substantially a cylindrical shape. The main pipe space 12C is formed continuously and smoothly from the first pipe portion 16 to the second pipe portion 14 and this smoothly transfers fuel supplied to the main pipe space 12C through the delivery pipe 10.

As illustrated in FIG. 2, branch holes 18 are formed on a peripheral surface of the second pipe portion 14. The branch hole 18 is open to a direction (a front side on a paper in FIG. 2) that is perpendicular to a direction indicated by an arrow 66 (an axial direction of the first pipe portion 16) and the direction X. The socket 22 is connected to a portion of the second pipe portion 14 corresponding to each branch hole 18. As illustrated in FIG. 3, the socket 22 is formed in a cylindrical shape and has a through hole 24 in its middle portion and the through hole 24 extends along an axial direction of the socket 22. An injector is to be connected to one end of the socket 22 and another end of the socket 22 is connected to the second pipe portion 14. The socket 22 is positioned such that the through hole 24 is communicated with the branch hole 18 of the second pipe portion 14. Therefore, connecting of the socket 22 to the main pipe 12 enables communication between an inner space 22C of the socket 22 and the main pipe space 12C of the main pipe 12 via the branch hole 18 and the through hole 24.

As illustrated in FIG. 2, a mounting boss 26 is connected to an outer peripheral surface of the first pipe portion 16 close to the branch hole 18 and on a side that the second pipe portion 14 is projected with respect to the axis Z of the first pipe portion 16. The mounting boss 26 is formed in a cylindrical shape and connected to the first pipe portion 16 such that its axis extends in a direction perpendicular to the arrow 66 and also perpendicular to the direction X. The mounting boss 26 has a mounting space 28 extending in its axial direction. A fixing member such as a bolt is inserted in the mounting space 28 of the mounting boss 26 and the fixing member is inserted in a fixing hole formed in a head of the engine 40. Accordingly, the delivery pipe 10 is fixed to the head of the engine 40.

A piping connector 62 is connected to one end 12A of the main pipe 12 and the main pipe 12 is connected to the fuel supply pipe P2 via the piping connector 62. Fuel supplied from the fuel supply pipe P2 passes through the main pipe space 12C of the main pipe 12 and distributed to each socket 22 via the branch hole 18 and supplied to the injector of the engine 40 to which the socket 22 is connected. Accordingly, fuel is injected into a combustion chamber of the engine by the injector when the engine 40 is activated, and this moves the vehicle 30.

Another end 12B of the main pipe 12 is connected to a pressure sensor connector 64 and is connected to a pressure sensor via the pressure sensor connector 64. The pressure sensor detects pressure of the fuel that is supplied to the delivery pipe 10 and this suppresses occurrence of operation errors of the engine 40 that are caused by excessive pressurizing or excessive depressurizing of the fuel.

3. Characteristics of Delivery Pipe

In the delivery pipe 10, according to the shape of the engine 40 that is to be mounted, the direction X in which the second pipe portion 14 is projected with respect to the axis Z and the distance L by which the second pipe portion 14 is projected with respect to the axis Z are determined. Also, according to the shape of the engine 40 that is to be mounted, the position of the outer peripheral surface of the first pipe portion 16 in which the mounting boss 26 is provided is determined. The configuration of the delivery pipe 10 is determined according to the shape of the engine 40. Therefore, the delivery pipe 10 is fixed to the head of the engine 40 and accordingly each socket 22 is connected to each injector provided in the head of the engine 40. Thus, the fuel that is supplied to the main pipe space 12C of the delivery pipe 10 is supplied to the engine 40 via the injectors.

4. Advantageous Effects of the Fuel Delivery Pipe of the Present Embodiment

(1) In internal combustion engines, the engine layout may be changed in response to requirements of improving engine ability or reducing a size of the engine. Most of conventional delivery pipes are configured by straight main pipe. Therefore, the positions of the branch holes and the mounting bosses can be freely determined in the axial direction of the main pipe according to the shape of the engine. However, the positions of the branch holes and the mounting bosses cannot be freely determined in the direction substantially perpendicular to the axial direction of the main pipe (the radial direction of the main pipe). The shape of the sockets or mounting bosses maybe changed to deal with such problems. However, this makes the shapes of the components to be complicated and if the shapes of the components are complicated, the manufacturing cost of the delivery pipes increases.

The delivery pipe 10 of the present embodiment includes the main pipe 12 that is formed by bending a pipe. Therefore, according to the shape of the engine 40 that is to be installed, the direction X in which the second pipe portion 14 is projected with respect to the axis Z and the distance L by which the second pipe portion 14 is projected with respect to the axis Z are determined, and also the position of the outer peripheral surface of the first pipe portion 16 in which the mounting boss 26 is connected is determined. Specifically, the mounting bosses 26 are provided on the outer peripheral surface of the first pipe portion 16 on the side that the second pipe portion 14 is projected with respect to the axis Z, and the distance L (an offset dimension) is set to be substantially equal to a radius of the main pipe 12. Accordingly, in the delivery pipe 10, the branch holes 18 and the mounting holes 28 of the mounting bosses 26 are arranged substantially on a line parallel to the axial direction of the main pipe 12 (the axis Z). This enables free engine layout.

Further, each of the second pipe portions 14 is projected in a same direction with respect to the axis of the first pipe portion 16. With this configuration, a distance between the mounting boss 26 and the branch hole 18 in the direction in which the second pipe portion 14 is projected with respect to the first pipe portion 16 can be set to be smaller than a radius of the main pipe 12. In other words, a difference between an offset dimension of the mounting boss 26 with respect to the axis of the first pipe portion 16 and an offset dimension of the branch hole 18 with respect to the axis of the first pipe portion 16 can be set smaller than the radius of the main pipe 12.

(2) In the delivery pipe 10 of the present embodiment, the shapes of the sockets 22 or the mounting bosses 26 are not necessary to be changed before and after the change of the engine layout and therefore the same sockets 22 and mounting bosses 26 can be used. This reduces a manufacturing cost of the delivery pipes 10. Accordingly, durability tests that are required by change of the components such as the sockets or the mounting bosses are not required to be carried out and problems are less likely to be caused in the delivery pipe 10.

(3) In the delivery pipe 10 of the present embodiment, the second pipe portion 14 is projected with respect to the axis Z and accordingly the position of the outer peripheral surface of the first pipe portion 16 in which the mounting boss 26 is provided is also determined. Therefore, the socket 22 and the mounting boss 26 are arranged on substantially a straight line along the axial direction of the main pipe 12. Further, the mounting boss 26 is arranged close to the second pipe portion 14 and therefore, the second pipe portion 14 is tightly fixed to the head of the engine 40. Accordingly, even if the main pipe 12 includes a curved portion such as the connecting portion 15 and the second pipe portion 14, vibration or noise is less likely to be caused when the fuel passes through the main pipe 12 of the delivery pipe 10.

### Other Embodiments

The embodiments of the present invention have been described, however, the present invention is not limited to the above embodiments explained in the above description and the drawings. The technology described herein includes various modifications of the above embodiments.

(1) In the above embodiment, the delivery pipe 10 is configured by connecting separate components of the main pipe 12, the sockets 22 and the mounting bosses 26. However, at least two of the components may integrally configure one component.

(2) In the above embodiment, the main pipe 12 of the delivery pipe 10 has a circular cross section. However, it is not limited thereto. For example, the cross section of the main pipe 12 of the delivery pipe 10 may be polygonal. The cross section of the socket 22 and the mounting boss 26 is not necessarily to be limited to the shape described in the above embodiment.

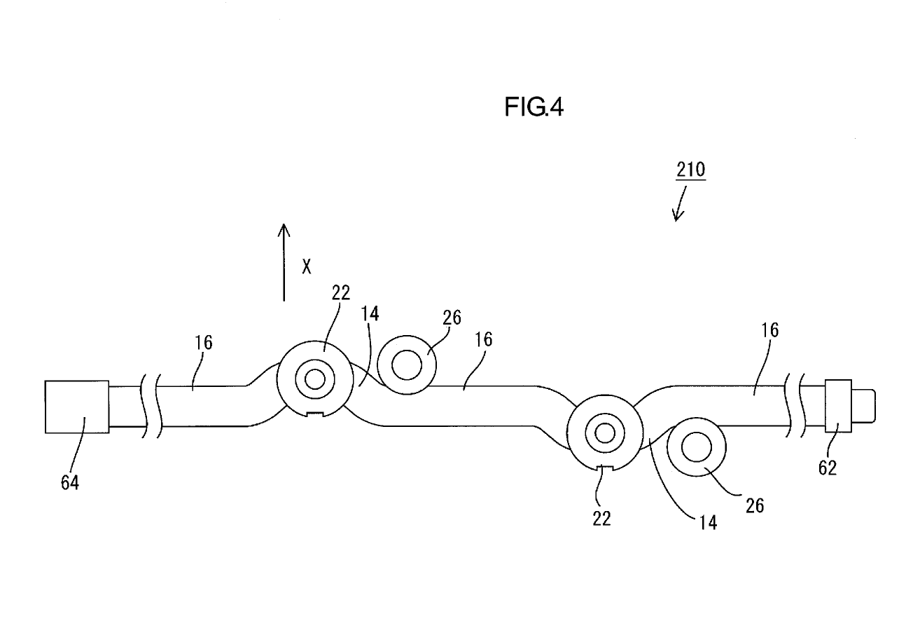

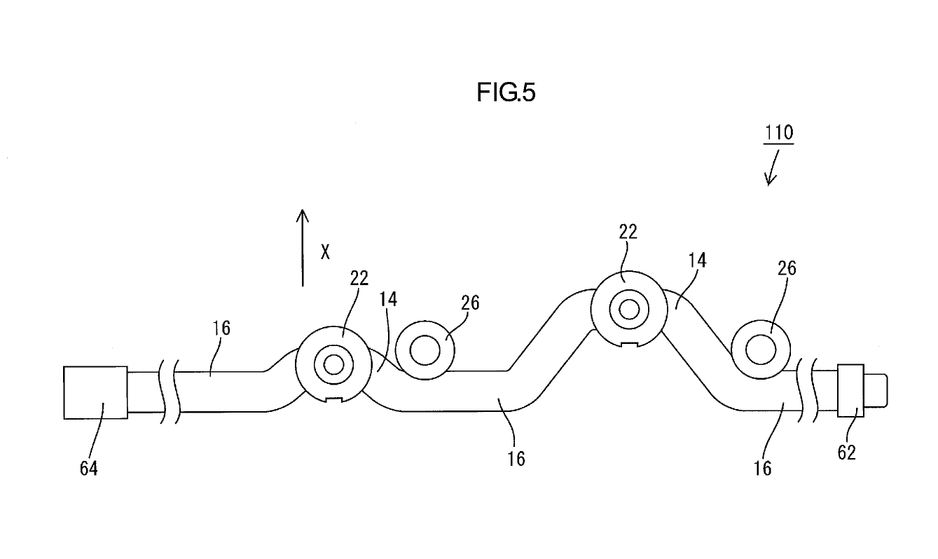

(3) In the above embodiment, each of the second pipe portions 14 is arranged to be projected by the same distance L in the same direction X (the radial direction) with respect to the axis Z. However, each of the second pipe portions is not necessarily projected by the same distance L in the same direction X with respect to the axis Z. As illustrated in FIG. 4, each of the second pipe portions 14 may be arranged to be projected in a different direction (in opposite directions from the axis Z) in a delivery pipe 210. As illustrated in FIG. 5, in a delivery pipe 110, each of the second pipe portions 14 may be arranged to be projected by a different distance in the same direction X (the radial direction) with respect to the axis Z.

(4) In the above embodiment, each of the mounting bosses 26 is connected to the outer peripheral surface of the first pipe portion 16 on the same side with respect to the axis Z. However, the mounting bosses 26 are not necessarily connected to the outer peripheral surface of the first pipe portion 16 on the same side with respect to the axis Z. As illustrated in FIG. 4, in the delivery pipe 210, each of the mounting bosses 26 is connected to the outer peripheral surface of the first pipe portion 16 on a different side with respect to the axis Z (opposite sides with respect to the axis Z).

(5) In the above embodiment, the mounting member is connected to the outer peripheral surface of the first pipe portion close to the branch hole and on a side that the second pipe portion is projected with respect to the axis Z of the first pipe portion. However, the mounting member may not be necessarily provided close to the branch hole and on the side that the second pipe portion is projected with respect to the axis of the first pipe portion. For example, the mounting member may be provided on the outer peripheral surface of the main pipe so as to be on a side opposite to the side that the second pipe portion is projected with respect to the axis of the first pipe portion.

Elements of technology described in this specification or illustrated in the drawings exert technical utility by each or a combination thereof. The elements of technology should not be limited to the combinations of the elements claimed in the original patent application. The technology described in this specification or illustrated in the drawings is provided for achieving multiple objectives at the same time. The technical utility of the technology is exerted when at least one of the objectives is achieved.

1. A fuel delivery pipe comprising:
a main pipe formed in a cylindrical shape and including a first pipe portion and a second pipe portion, the second pipe portion being continuously formed from the first pipe portion and projected in a direction substantially perpendicular to an axis of the first pipe portion; and
a mounting member provided on an outer peripheral surface of the main pipe and close to the second pipe portion.

2. The fuel delivery pipe according to claim 1, wherein the mounting member is provided on a side that the second pipe portion is projected with respect to the axis of the first pipe portion.

3. The fuel delivery pipe according to claim 1, wherein the second pipe portion has a branch hole on its peripheral surface, and the branch hole makes inside and outside of the main pipe to be communicated with each other.

4. The fuel delivery pipe according to claim 2, wherein the second pipe portion has a branch hole on its peripheral surface, and the branch hole makes inside and outside of the main pipe to be communicated with each other.

5. The fuel delivery pipe according to claim 3, further comprising a connecting member provided on a portion of the second pipe portion in which the branch hole is formed.

6. The fuel delivery pipe according to claim 4, further comprising a connecting member provided on a portion of the second pipe portion in which the branch hole is formed.

7. The fuel delivery pipe according to claim 1, wherein the second pipe portion is a curved portion formed by bending.

8. The fuel delivery pipe according to claim 2, wherein the second pipe portion is a curved portion formed by bending.

9. The fuel delivery pipe according to claims 7, the first pipe portion is substantially straight.

10. The fuel delivery pipe according to claim 1, wherein the first pipe portion includes a plurality of first pipe portions and the second pipe portion includes a plurality of second pipe portions and the first pipe portions and the second pipe portions are arranged alternately.

11. The fuel delivery pipe according to claim 2, wherein the first pipe portion includes a plurality of first pipe portions and the second pipe portion includes a plurality of second pipe portions and the first pipe portions and the second pipe portions are arranged alternately.

12. The fuel delivery pipe according to claim 10, wherein each of the second pipe portions is projected in a same direction with respect to the axis of the first pipe portion.

13. The fuel delivery pipe according to claim 11, wherein each of the second pipe portions is projected in a same direction with respect to the axis of the first pipe portion.

14. The fuel delivery pipe according to claim 10, wherein each of at least two second pipe portions is projected in a different direction with respect to the axis of the first pipe portion.

15. The fuel delivery pipe according to claim 11, wherein each of at least two second pipe portions is projected in a different direction with respect to the axis of the first pipe portion.

16. The fuel delivery pipe according to claim 3, wherein the branch hole is open to a direction that is substantially perpendicular to a direction in which the second pipe portion is projected with respect to the first pipe portion and also substantially perpendicular to an axial direction of the first pipe portion.
